(19) United States
(12) Patent Application Publication
(10) Pub. No.: US 2024/0345552 A1
(43) Pub. Date: Oct. 17, 2024

(54) Distributed Machine Learning for a Thermostat

(71) Applicant: Computime Limited, Hong Kong (HK)

(72) Inventors: Wai Leung Ha, Hong Kong (HK); Chi Shing Raymond Wong, Hong Kong (HK); Pak Ming Fan, Hong Kong (HK); Mu Li, Hong Kong (HK)

(21) Appl. No.: 18/632,355

(22) Filed: Apr. 11, 2024

Related U.S. Application Data
(60) Provisional application No. 63/495,350, filed on Apr. 11, 2023.

(51) Int. Cl. G05B 13/02; F24F 11/58; F24F 11/64; F24F 110/10; F24F 110/12; G06N 3/045

(52) U.S. Cl. CPC G05B 13/027; F24F 11/58; F24F 11/64; G06N 3/045; F24F 2110/10; F24F 2110/12

(57) ABSTRACT

Current thermostat data including room temperature readings, thermostat control commands, and user input temperature set point changes is collected. The current thermostat data is sent from a thermostat to a cloud server that creates and continually updates a first server machine learning model trained using previous and the current thermostat data, a second thermostat machine learning model is created for sending control commands to the thermostat using the previous and the current thermostat data, and the second thermostat machine learning model is updated. The second thermostat machine learning model is updated by sending updated model parameters from the first server machine learning model to the second thermostat machine learning model. One or more new thermostat commands determined from the current thermostat data are received from the second thermostat machine learning model and the one or more new thermostat commands are executed.

### RELATED APPLICATIONS

This application claims the benefit of U.S. Provisional Patent Application Ser. No. 63/495,350, filed on Apr. 11, 2023, the content of which is incorporated by reference herein in its entirety.

### FIELD OF THE INVENTION

The teachings herein relate to systems and methods for predicting the thermal characteristics of a room under the control of a thermostat.

### BACKGROUND

It is well known that energy can be saved by heating or cooling a room using a thermostat that can be adjusted automatically based on the time and temperature. However, the heating or cooling decision is often also a function of user inputs in addition to the time and temperature.

As a result, there is a need for systems and methods that monitor the use of a thermostat in addition to the time and temperature to predict a model that can be used to optimally and automatically adjust the thermostat.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is an exemplary diagram of a system for controlling the temperature of a room, in accordance with various embodiments.

FIG. 3 is an exemplary diagram of the system of FIG. 2 that includes a proportional integral and differential (PID) or time proportional integral (TPI) for interpreting PID or TPI commands, in accordance with various embodiments.

FIG. 4 is an exemplary diagram of a system for controlling the temperature of a room that further includes a gateway controller, in accordance with various embodiments.

FIG. 5 is an exemplary diagram of the system of FIG. 4 that includes a PID or TPI control module for interpreting PID or TPI commands, in accordance with various embodiments.

FIG. 6 is a flowchart showing a method for controlling the temperature of a room, in accordance with various embodiments.

FIG. 7 is a schematic diagram of a system that includes one or more distinct software modules and that performs a method for controlling the temperature of a room, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF EMBODIMENTS

### Computer-Implemented System

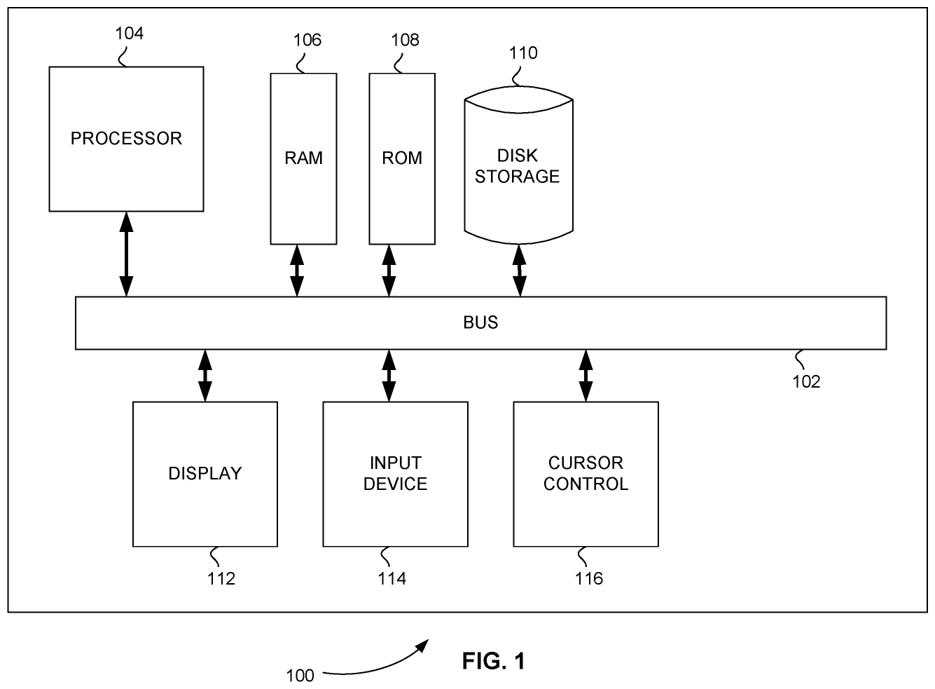

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random-access memory (RAM) or other dynamic storage device, coupled to bus 102 for storing instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein.

Alternatively, hard-wired circuitry may be used in place of or in combination with software instructions to implement the present teachings. For example, the present teachings may also be implemented with programmable artificial intelligence (AI) chips with only the encoder neural network programmed-to allow for performance and decreased cost. Thus, implementations of the present teachings are not limited to any specific combination of hardware circuitry and software.

The term “computer-readable medium” or “computer program product” as used herein refers to any media that participates in providing instructions to processor 104 for execution. The terms “computer-readable medium” and “computer program product” are used interchangeably throughout this written description. Such a medium may take many forms, including but not limited to, non-volatile media and volatile media. Non-volatile media includes, for example, optical or magnetic disks, such as storage device 110. Volatile media includes dynamic memory, such as memory 106.

Common forms of computer-readable media include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### Machine Learning Thermostat System

As described above, there is a need for systems and methods that monitor the use of a thermostat in addition to the time and temperature to predict a model that can be used to optimally and automatically adjust the thermostat.

In various embodiments, thermal characteristic prediction of a room under the control of a thermostat is performed with data reporting to the cloud. The thermal characteristics are modeled in a cloud system with training performed using historical data and a machine learning model. With the predicted characteristic and expected temperature change, actions are taken by a thermostat to enable further energy saving while maintaining reasonable comfort for the room. Various embodiments create a machine learning model that runs mainly on a cloud server by making use of its powerful processing capability and resources. There is a part of the model distributed to the thermostat to help execute part of the model and continue to gather new data and reinforce the machine learning model locally. All the data is transferred back to the cloud for further training to continue improving the model's accuracy and performance.

In various embodiments, a machine learning model includes or is created in two parts, one running on the cloud and the other running on a local gateway. The cloud machine learning model continues to build the model with historical and new data. The local machine learning model responds to the latest information collected, such as local temperature, outside temperature, and set point. The local model sends direct on and off commands to control the thermostat based on the model's decision. The local model also makes minor adjustments based on the latest inputs until new model parameters are received from the cloud after further learning and training with both historical and current data.

In various embodiments, the gateway can also work with a thermostat that supports or includes a proportional integral and differential (PID) control module and a time proportional integral (TPI) control module. Instead of supplying direct control commands, the local machine learning module updates the parameters of PID and TPI to achieve energy saving while keeping the comfortability.

In various embodiments, for thermostats working with the cloud directly, such as, Wi-Fi-based thermostats without a gateway, the local machine learning model resides inside the thermostat and works together with the cloud machine learning model to control the thermostat.

In various embodiments, if the thermostat works directly with the cloud but supports PID or TPI, the local machine learning module works with the PID or TPI module by updating the parameter of the module instead of direct control of a relay on or off.

### System for Controlling the Temperature of a Room

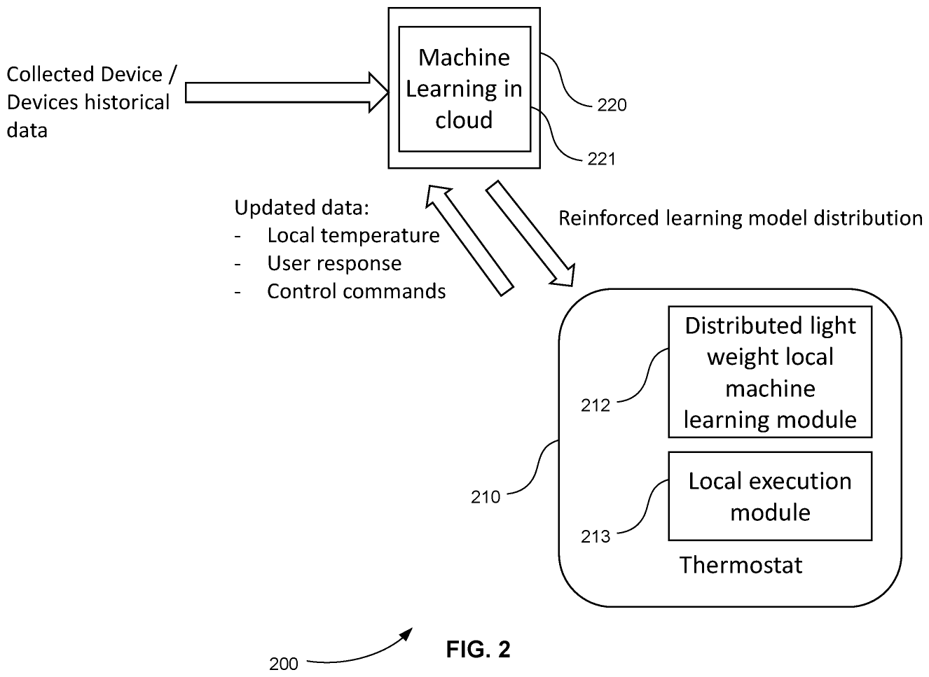

FIG. 2 is an exemplary diagram 200 of a system for controlling the temperature of a room, in accordance with various embodiments. The system of FIG. 2 includes thermostat 210. Thermostat 210 is in the room of a building, for example. Thermostat 210 collects current thermostat data. Thermostat data can include, but is not limited to, room temperature readings, thermostat control commands, and user input temperature set point changes. Thermostat data is time series data or data that is taken over time. The time also includes the date, for example. Thermostat 210 sends the current thermostat data to cloud server 220.

Cloud server 220 can include one or more processors that can be, but are not limited to, a controller, a computer, a microprocessor, the computer system of FIG. 1, or any device capable of sending and receiving control signals or data and analyzing data. Cloud server 220 creates and continually updates a first server machine learning model 221 trained using previous and the current thermostat data. Previous or historical thermostat data is stored in a cloud memory (not shown), for example.

Cloud server 220 creates a second thermostat machine learning model 212 for sending control commands to the thermostat using the previous and the current thermostat data. Cloud server 220 updates second thermostat machine learning model 212 by sending updated model parameters from first server machine learning model 221 to second thermostat machine learning model 212 when first server machine learning model 221 is updated.

Second thermostat machine learning model 212 is used to control the temperature of the room. Second thermostat machine learning model 212 receives current thermostat data, determines one or more new thermostat commands from second thermostat machine learning model 212 and sends the one or more new thermostat commands to thermostat 210.

One of ordinary skill in the art understands that machine learning generally involves a machine learning algorithm that receives historical and current data that are used to create and train a machine learning model. In various embodiments, first server machine learning model 221 is a machine learning algorithm and second thermostat machine learning model 212 is a machine learning model. The machine learning models that can be used including, CNN, RNN, LSTM, DNN, Transformer, BERT, GPT, combination and enhancement of the above models and any other models.

In various embodiments, the current thermostat data can further include an outside temperature. This is, for example, a temperature that is measured outside of the building in which the room is located.

As shown in FIG. 2, second thermostat machine learning model 212 is created on the cloud server, distributed to thermostat 210, and executed on thermostat 210. Thermostat 210 can include one or more processors that can be, but are not limited to, a controller, a computer, a microprocessor, the computer system of FIG. 1, or any device capable of sending and receiving control signals or data and analyzing data.

As shown in FIG. 2, the one or more new thermostat commands include on or off commands for thermostat 210. On or off commands turn on or off a heating or cooling unit using a relay or electronic switch, for example. These one or more new thermostat commands are executed using a local execution module (or software) 213 operating on a processor of thermostat 210, for example. Note that when the one or more new thermostat commands are on or off commands the thermostat control commands of the current thermostat data are also on or off commands.

In various alternative embodiments, the one or more new thermostat commands include PID or TPI commands. In other words, second thermostat machine learning model 212 produces PID or TPI commands in response to receiving the current thermostat data. Note that when the one or more new thermostat commands are PID or TPI commands the thermostat control commands of the current thermostat data are also PID or TPI commands.

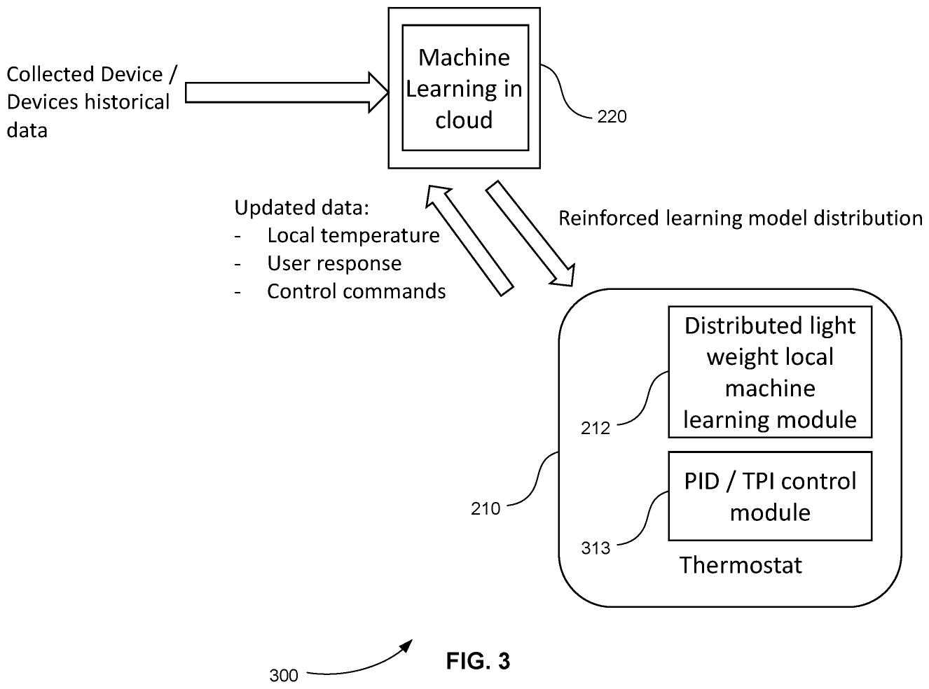

FIG. 3 is an exemplary diagram 300 of the system of FIG. 2 that includes a PID or TPI control module for interpreting PID or TPI commands, in accordance with various embodiments. As a result, second thermostat machine learning model 212 produces one or more new thermostat commands that are PID or TPI parameters for PID or TPI control module 313. In turn, PID or TPI control module 313 determines the appropriate heating or cooling settings from the PID or TPI parameters.

In various embodiments, a gateway controller is located between cloud server 220 and thermostat 210.

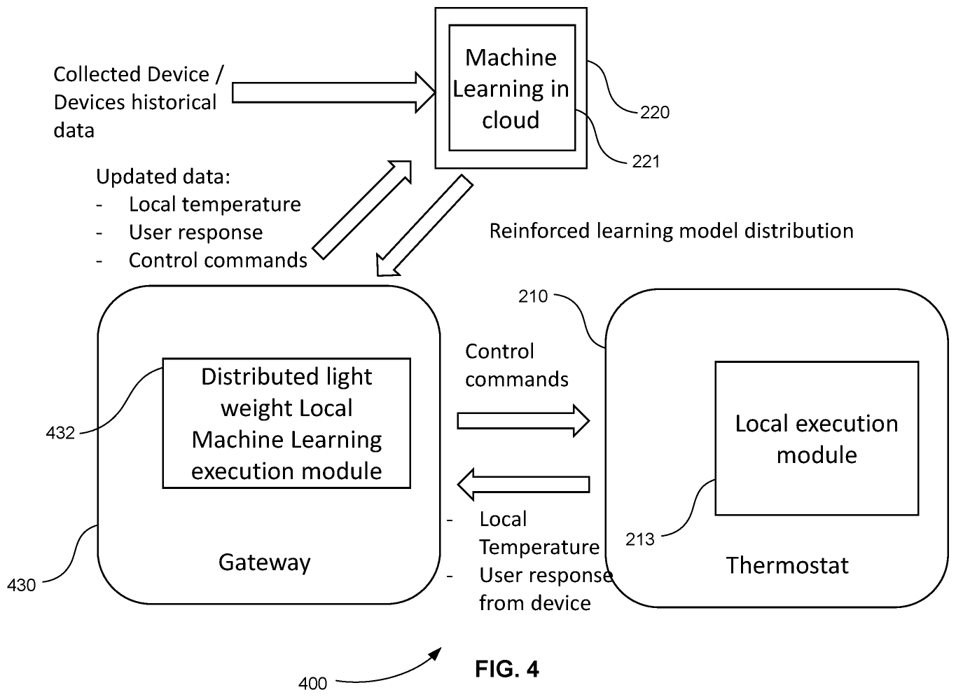

FIG. 4 is an exemplary diagram 400 of a system for controlling the temperature of a room that further includes a gateway controller, in accordance with various embodiments. Gateway controller 430 is in communication with cloud server 220 and thermostat 210. Gateway controller 430 can include one or more processors that can be, but are not limited to, a controller, a computer, a microprocessor, the computer system of FIG. 1, or any device capable of sending and receiving control signals or data and analyzing data.

Gateway controller 430 receives the current thermostat data from thermostat 210 and sends the current thermostat data to cloud server 220. Second thermostat machine learning model 432 is created on cloud server 220, distributed to gateway controller 430, and executed on gateway controller 430.

Cloud server 220 updates second thermostat machine learning model 432 by sending updated model parameters to second thermostat machine learning model 432 on gateway controller 430 when first server machine learning model 221 is updated on cloud server 220. Second thermostat machine learning model 432 on gateway controller 430 controls the temperature of the room by receiving current thermostat data from thermostat 410, determining one or more new thermostat commands from second thermostat machine learning model 432 and sending the one or more new thermostat commands from gateway controller 430 to thermostat 410.

As shown in FIG. 4, the one or more new thermostat commands include on or off commands for thermostat 210. On or off commands turn on or off a heating or cooling unit using a relay or electronic switch, for example. These one or more new thermostat commands are executed using local execution module 213 operating on a processor of thermostat 210, for example.

In various alternative embodiments, the one or more new thermostat commands include PID or TPI commands. In other words, second thermostat machine learning model 432 produces PID or TPI commands in response to receiving the current thermostat data.

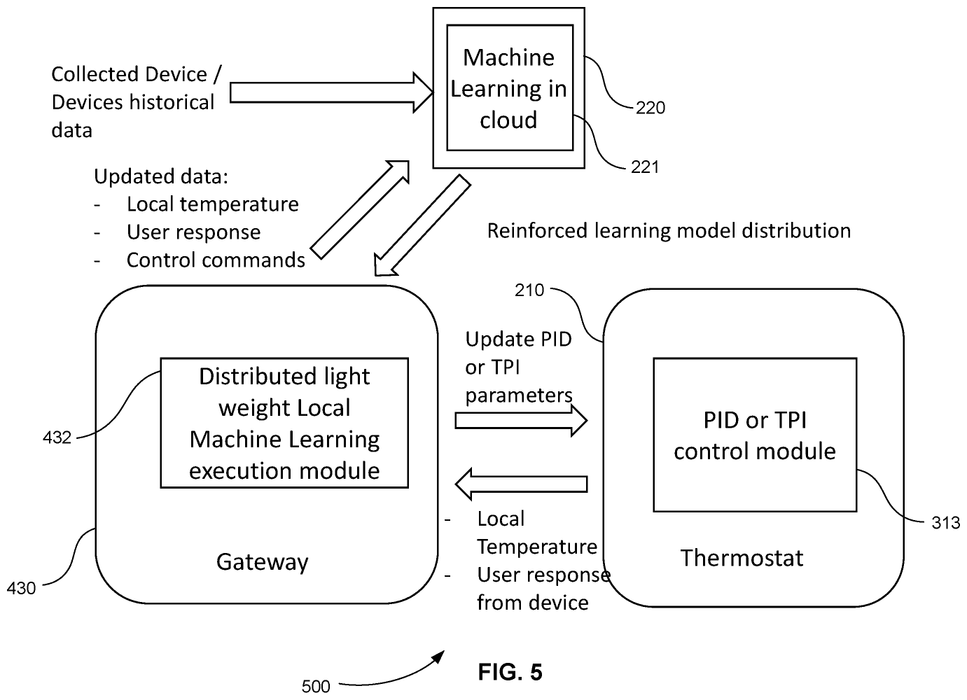

FIG. 5 is an exemplary diagram 500 of the system of FIG. 4 that includes a PID or TPI control module for interpreting PID or TPI commands, in accordance with various embodiments. As a result, second thermostat machine learning model 432 produces one or more new thermostat commands that are PID or TPI parameters for PID or TPI control module 313. In turn, PID or TPI control module 313 determines the appropriate heating or cooling settings from the PID or TPI parameters.

### Method for Controlling the Temperature of a Room

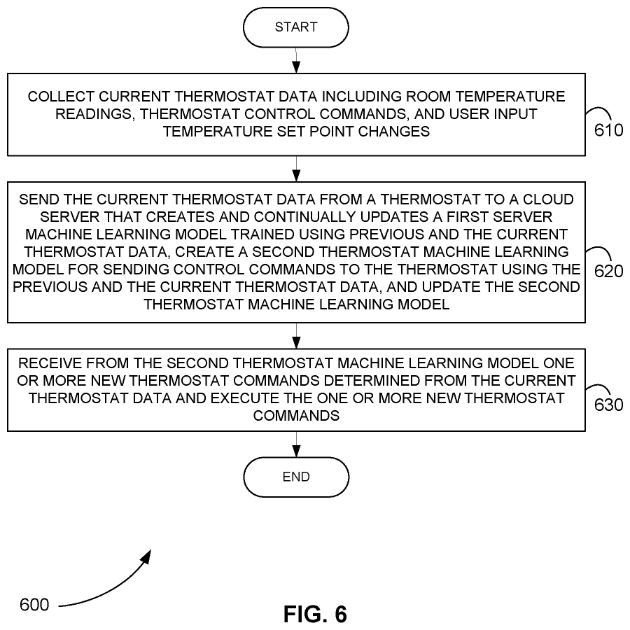

FIG. 6 is a flowchart showing a method 600 for controlling the temperature of a room, in accordance with various embodiments.

In step 610 of method 600, current thermostat data including room temperature readings, thermostat control commands, and user input temperature set point changes is collected.

In step 620, the current thermostat data is sent from a thermostat to a cloud server that creates and continually updates a first server machine learning model trained using previous and the current thermostat data, a second thermostat machine learning model is created for sending control commands to the thermostat using the previous and the current thermostat data, and the second thermostat machine learning model is updated. The second thermostat machine learning model is updated by sending updated model parameters from the first server machine learning model to the second thermostat machine learning model when the first server machine learning model is updated using the thermostat.

In step 630, one or more new thermostat commands determined from the current thermostat data are received from the second thermostat machine learning model and the one or more new thermostat commands are executed.

### Computer Program Product for Controlling the Temperature of a Room

In various embodiments, a computer program product includes a non-transitory tangible computer-readable storage medium whose contents include a program with instructions being executed on a processor so as to perform a method for controlling the temperature of a room. The processor can be, but is not limited to, a controller, a computer, a microprocessor, the computer system of FIG. 1, or any device capable of providing control signals and analyzing data. This method is performed by a system that includes one or more distinct software modules.

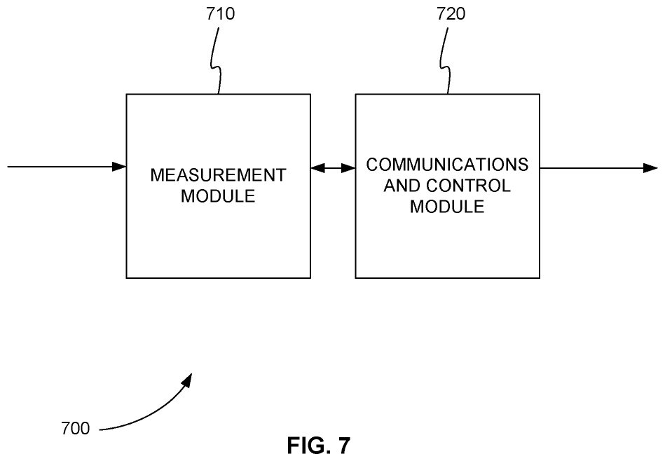

FIG. 7 is a schematic diagram of a system 700 that includes one or more distinct software modules and that performs a method for controlling the temperature of a room, in accordance with various embodiments. System 700 includes measurement module 710 and communications and control module 720.

Measurement module 710 collects current thermostat data including room temperature readings, thermostat control commands, and user input temperature set point changes.

Communications and control module 720 sends the current thermostat data from a thermostat to a cloud server that creates and continually updates a first server machine learning model trained using previous and the current thermostat data, creates a second thermostat machine learning model for sending control commands to the thermostat using the previous and the current thermostat data, and updates the second thermostat machine learning model. The second thermostat machine learning model is updated by sending updated model parameters from the first server machine learning model to the second thermostat machine learning model when the first server machine learning model is updated using the thermostat.

Communications and control module 720 receives from the second thermostat machine learning model one or more new thermostat commands determined from the current thermostat data and executes the one or more new thermostat commands.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A system for controlling the temperature of a room, comprising:
a thermostat in the room that collects current thermostat data including room temperature readings, thermostat control commands, and user input temperature set point changes and sends the current thermostat data to a cloud server,
wherein the cloud server creates and continually updates a first server machine learning model trained using previous and the current thermostat data, creates a second thermostat machine learning model for sending control commands to the thermostat using the previous and the current thermostat data, and updates the second thermostat machine learning model by sending updated model parameters from the first server machine learning model to the second thermostat machine learning model when the first server machine learning model is updated,
wherein the second thermostat machine learning model controls the temperature of the room by receiving current thermostat data, determining one or more new thermostat commands from the second thermostat machine learning model and sending the one or more new thermostat commands to the thermostat.

2. The system of claim 1, wherein the current thermostat data further comprises an outside temperature.

3. The system of claim 1, wherein the second thermostat machine learning model is created on the cloud server, distributed to the thermostat, and executed on the thermostat.

4. The system of claim 1,
wherein a gateway controller in communication with the cloud server and the thermostat receives the current thermostat data from the thermostat and sends the current thermostat data to the cloud server,
wherein the second thermostat machine learning model is created on the cloud server, distributed to the gateway controller, and executed on the gateway controller,
wherein the cloud server updates the second thermostat machine learning model by sending updated model parameters to the second thermostat machine learning model on the gateway controller when the first server machine learning model is updated on the cloud server, and
wherein the second thermostat machine learning model on the gateway controller controls the temperature of the room by receiving current thermostat data from the thermostat, determining one or more new thermostat commands from the second thermostat machine learning model and sending the one or more new thermostat commands from the gateway controller to the thermostat.

5. The system of claim 1, wherein the one or more new thermostat commands comprise on or off commands for the thermostat.

6. The system of claim 1, wherein the thermostat further comprises a proportional integral and differential (PID) control module and the one or more new thermostat commands comprise PID parameters.

7. The system of claim 1, wherein the thermostat further comprises a time proportional integral (TPI) control module and the one or more new thermostat commands comprise TPI parameters.

8. A method for controlling the temperature of a room, comprising:
collecting current thermostat data including room temperature readings, thermostat control commands, and user input temperature set point changes;
sending the current thermostat data from a thermostat to a cloud server that creates and continually updates a first server machine learning model trained using previous and the current thermostat data, creating a second thermostat machine learning model for sending control commands to the thermostat using the previous and the current thermostat data, and updating the second thermostat machine learning model by sending updated model parameters from the first server machine learning model to the second thermostat machine learning model when the first server machine learning model is updated; and
receiving from the second thermostat machine learning model one or more new thermostat commands determined from the current thermostat data and executing the one or more new thermostat commands.

9. The method of claim 8, wherein the current thermostat data further comprises an outside temperature.

10. The method of claim 8, wherein the second thermostat machine learning model is created on the cloud server, distributed to the thermostat, and executed on the thermostat.

11. The method of claim 8,
wherein a gateway controller in communication with the cloud server and the thermostat receives the current thermostat data from the thermostat and sends the current thermostat data to the cloud server,
wherein the second thermostat machine learning model is created on the cloud server, distributed to the gateway controller, and executed on the gateway controller,
wherein the cloud server updates the second thermostat machine learning model by sending updated model parameters to the second thermostat machine learning model on the gateway controller when the first server machine learning model is updated on the cloud server, and
wherein the second thermostat machine learning model on the gateway controller controls the temperature of the room by receiving current thermostat data from the thermostat, determining one or more new thermostat commands from the second thermostat machine learning model and sending the one or more new thermostat commands from the gateway controller to the thermostat.

12. The method of claim 8, wherein the one or more new thermostat commands comprise on or off commands for the thermostat.

13. The method of claim 8, wherein the thermostat further comprises a proportional integral and differential (PID) control module and the one or more new thermostat commands comprise PID parameters.

14. The method of claim 8, wherein the thermostat further comprises a time proportional integral (TPI) control module and the one or more new thermostat commands comprise TPI parameters.

15. A computer program product, comprising a non-transitory tangible computer-readable storage medium whose contents cause a processor to perform a method for controlling the temperature of a room, comprising:
providing a system, wherein the system comprises one or more distinct software modules, and wherein the distinct software modules comprise a measurement module and a communications and control module;
collecting current thermostat data including room temperature readings, thermostat control commands, and user input temperature set point changes using the measurement module;
sending the current thermostat data from a thermostat to a cloud server that creates and continually updates a first server machine learning model trained using previous and the current thermostat data, creating a second thermostat machine learning model for sending control commands to the thermostat using the previous and the current thermostat data, and updating the second thermostat machine learning model by sending updated model parameters from the first server machine learning model to the second thermostat machine learning model when the first server machine learning model is updated using the communications and control module; and
receiving from the second thermostat machine learning model one or more new thermostat commands determined from the current thermostat data and executing the one or more new thermostat commands using the communications and control module.

16. The computer program product of claim 15, wherein the current thermostat data further comprises an outside temperature.

17. The computer program product of claim 15, wherein the second thermostat machine learning model is created on the cloud server, distributed to the thermostat, and executed on the thermostat.

18. The computer program product of claim 15,
wherein a gateway controller in communication with the cloud server and the thermostat receives the current thermostat data from the thermostat and sends the current thermostat data to the cloud server,
wherein the second thermostat machine learning model is created on the cloud server, distributed to the gateway controller, and executed on the gateway controller,
wherein the cloud server updates the second thermostat machine learning model by sending updated model parameters to the second thermostat machine learning model on the gateway controller when the first server machine learning model is updated on the cloud server, and
wherein the second thermostat machine learning model on the gateway controller controls the temperature of the room by receiving current thermostat data from the thermostat, determining one or more new thermostat commands from the second thermostat machine learning model and sending the one or more new thermostat commands from the gateway controller to the thermostat.

19. The computer program product of claim 15, wherein the one or more new thermostat commands comprise on or off commands for the thermostat.

20. The computer program product of claim 15, wherein the thermostat further comprises a proportional integral and differential (PID) control module or a time proportional integral (TPI) control module and the one or more new thermostat commands comprise PID or TPI parameters.
